(19) United States
(12) Patent Application Publication
(10) Pub. No.: US 2024/0158165 A1
(43) Pub. Date: May 16, 2024

(54) AN AUTOMATED STORAGE SYSTEM

(71) Applicant: Autostore Technology AS, Nedre Vars (NO)

(72) Inventors: Trond Austrheim, Etne (NO); Ivar Fjeldheim, Haugesund (NO)

(73) Assignee: Autostore Technology AS, Nedre Vats (NO)

(21) Appl. No.: 18/280,592

(22) PCT Filed: Mar. 4, 2022
(86) PCT No.: PCT/EP2022/055607

§ 371 Date: Sep. 6, 2023

(30) Foreign Application Priority Data
Mar. 9, 2021 (NO) 20210308

(51) Int. Cl. B65G 1/04

(52) U.S. Cl. CPC B65G 1/0464; F25D 13/02

(57) ABSTRACT

A storage system includes a framework structure featuring multiple storage columns in which storage containers are stored stacked on top of one another in vertical stacks, and at least one of the storage columns includes a cover and a pair of cover interaction elements. The cover includes a horizontal cover plate, having a periphery that can be accommodated within an inner periphery of the storage column, and at least two cover holding assemblies arranged at opposite sides of the cover plate. The cover interaction elements are arranged each at opposite sides of the inner periphery of the storage column. Each of the cover holding assemblies includes a stop and an actuator portion, and is pivotably connected relative to the cover plate such that the stop is moved in a horizontal direction outwardly beyond the inner periphery of the storage column, from a first position to a second position, when the actuator portion is deflected inwardly of the inner periphery of the storage column by interaction with a corresponding cover interaction element during lowering of the cover relative to the storage column. The stop is biased towards the first position and arranged to hold the cover at a predetermined level by interaction with a ledge at the inner periphery of the storage column when in the second position.

### FIELD OF THE INVENTION

The present invention relates to a storage system, more particularly to a storage system featuring removable covers that may be arranged at an upper level of the storage system.

### BACKGROUND AND PRIOR ART

FIG. 1 discloses a typical prior art automated storage and retrieval system 1 with a framework structure 100 and FIGS. 2 to 4 disclose two different prior art container handling vehicles 201,301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminium profiles.

The framework structure 100 of the automated storage and retrieval system 1 comprises a rail system 108 arranged in a grid pattern across the top of the framework structure 100, on which rail system 108 a plurality of container handling vehicles 201,301 are operated to raise storage containers 106 from, and lower storage containers 106 into, the storage columns 105, and also to transport the storage containers 106 above the storage columns 105. The horizontal extent of one of the grid cells 122 constituting the grid pattern is marked by thick lines.

The rail system 108 (i.e. a rail grid) comprises a first set of parallel rails 110 arranged to guide movement of the container handling vehicles 201,301 in a first direction X across the top of the frame structure 100, and a second set of parallel rails 111 arranged perpendicular to the first set of rails 110 to guide movement of the container handling vehicles 201,301 in a second direction Y which is perpendicular to the first direction X. Containers 106 stored in the columns 105 are accessed by the container handling vehicles through access openings 112 in the rail system 108. The container handling vehicles 201,301 can move laterally above the storage columns 105, i.e. in a plane which is parallel to the horizontal X-Y plane. Commonly, at least one of the sets of rails 110,111 is made up of dual-track rails allowing two container handling vehicles to pass each other on neighbouring grid cells 122. Dual-track rails are well-known and disclosed in for instance WO 2015/193278 A1 and WO 2015/140216 A1, the contents of which are incorporated herein by reference.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301 comprises a vehicle body 201a,301a, and first and second sets of wheels 201b,301b,201c,301c which enable the lateral movement of the container handling vehicles 201,301 in the X direction and in the Y direction, respectively. In FIGS. 2 and 3 two wheels in each set are fully visible. The first set of wheels 201b,301b is arranged to engage with two adjacent rails of the first set 110 of rails, and the second set of wheels 201c,301c is arranged to engage with two adjacent rails of the second set 111 of rails. At least one of the sets of wheels 201b,301b,201c,301c can be lifted and lowered, so that the first set of wheels 201b,301b and/or the second set of wheels 201c,301c can be engaged with the respective set of rails 110, 111 at any one time.

Each prior art container handling vehicle 201,301 also comprises a container lifting assembly 2 (shown in FIG. 4) for vertical transportation of storage containers 106, e.g. raising a storage container 106 from, and lowering a storage container 106 into, a storage column 105. The container lifting assembly 2 comprises a lifting frame 3 having one or more gripping/engaging devices 4 adapted to engage a storage container 106 and guide pins 304 for correct positioning of the lifting frame 3 relative to the storage container 106. The lifting frame 3 can be lowered from the vehicle 201,301 by lifting bands 5 so that the position of the lifting frame with respect to the vehicle 201,301 can be adjusted in a third direction Z which is orthogonal the first direction X and the second direction Y.

The lifting frame 3 (not shown) of the container handling vehicle 201 in FIG. 2 is located within a cavity of the vehicle body 201a, while the lifting frame 3 of the container handling vehicle 301 in FIGS. 3 and 4 is suspended from a cantilevered section 6.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301 comprises a storage compartment or space for receiving and stowing a storage container 106 when transporting the storage container 106 across the rail system 108. The storage space may comprise a cavity arranged centrally within the vehicle body 201a as shown in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 201 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising e.g. belt or roller conveyors may be employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

Belt and/or roller conveyors are relatively expensive and often service intensive. To avoid use of such conveyors, some access stations may have a section arrangeable directly below a port column such that a storage container may be transferred directly to the access station. Prior art access stations suitable for being arranged below a port column are disclosed in for example WO 2012/026824 A1 and WO 2016/120375 A1. The prior art access stations may move a storage container from a position below a port column to a picking/stocking position (or access position) by a radial movement around a rotational axis. An operator has access to the content of the storage container at the picking/stocking position.

When a storage container 106 stored in one of the columns 105 disclosed in FIG. 1 is to be accessed, one of the container handling vehicles 201,301 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301 a container lifting assembly 2 (shown in FIG. 4), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles specifically dedicated to the task of temporarily removing storage containers from a storage column 105. Once the target storage container 106 has been removed from the storage column 105, the temporarily removed storage containers can be repositioned into the original storage column 105. However, the removed storage containers may alternatively be relocated to other storage columns.

When a storage container 106 is to be stored in one of the columns 105, one of the container handling vehicles 201,301 is instructed to pick up the storage container 106 from the pick-up port column 120 and transport it to a location above the storage column 105 where it is to be stored. After any storage containers positioned at or above the target position within the storage column stack 107 have been removed, the container handling vehicle 201,301 positions the storage container 106 at the desired position. The removed storage containers may then be lowered back into the storage column 105 or relocated to other storage columns.

For monitoring and controlling the automated storage and retrieval system 1, e.g. monitoring and controlling the location of respective storage containers 106 within the framework structure 100, the content of each storage container 106; and the movement of the container handling vehicles 201,301 so that a desired storage container 106 can be delivered to the desired location at the desired time without the container handling vehicles 201,301 colliding with each other, the automated storage and retrieval system 1 comprises a control system 500 which typically is computerized and which typically comprises a database for keeping track of the storage containers 106.

The upper ends of the storage columns 105 are commonly fully open to the surroundings and the temperature conditions and atmosphere within the storage system and in the surroundings are consequently the same. However, in many applications it is desirable to control the temperature conditions and/or the atmosphere within at least parts of the storage system independently of other parts of the storage system and/or the surroundings. These applications include use of the storage system for freezing and/or cooling of stored items, as well as changing the atmosphere of at least parts of the storage system. The latter may for instance entail filling the storage system with an inert gas, in case of a fire, and with air having an increased CO₂ content when the storage system is used for cultivation of plants, i.e. vertical farming.

WO 2015/124610 A1 discloses a storage system configured for cooling items stored in the stacked storage containers. The storage system features insulated lids arranged at the upper end of each storage column to insulate the storage containers from the surroundings.

A consequence of the open storage columns is that a human operator may not walk on top of the storage system. Being able to move on top of the storage system may be highly advantageous in situations wherein various equipment arranged on the rail system 8 require service or repair.

WO 2019/081092 A1 discloses a storage system wherein a human operator may walk upon the storage system by using covers forming a path from a side section of the storage system to the equipment in need of service. The covers are supported on a stack of storage containers.

An object of the present invention is to provide an improved storage system in which the temperature and/or atmosphere may be controlled in at least a section of the storage system.

A further object of the present invention is to provide an improved storage system in which a path for a human operator may be arranged on top of a framework structure.

### SUMMARY OF THE INVENTION

The present invention is defined by the attached claims and in the following:

In a first aspect, the present invention provides a storage system comprising a framework structure featuring multiple storage columns in which storage containers are stored stacked on top of one another in vertical stacks, and at least one of the storage columns comprises a cover and two cover interaction elements, wherein
the cover comprises a horizontal cover plate, having a periphery that can be accommodated within an inner periphery of the storage column, and at least two cover holding assemblies arranged at opposite sides of the cover plate;
the two cover interaction elements are arranged at opposite sides of the inner periphery of the storage column;
each of the cover holding assemblies comprises a stop and an actuator portion, and is pivotably connected relative to the cover plate such that the stop is moved in a horizontal direction outwardly beyond the inner periphery of the storage column, from a first position to a second position, when the actuator portion is deflected inwardly of the inner periphery of the storage column by interaction with a corresponding cover interaction element during lowering of the cover relative to the storage column; and
the stop is biased towards the first position and arranged to hold the cover at a predetermined level by interaction with an edge at the inner periphery of the storage column when in the second position.

The inner periphery of the storage column may be defined as corresponding to an inner periphery of a rectangular opening of the storage columns, the opening being arranged at the top of the storage column. The inner periphery of the rectangular opening is set by the sides of a set of rails delimiting the opening, where the rails are part of a rail grid arranged at an upper level of the framework structure.

In the second position, a section of the stop extends beyond the inner periphery of the storage column.

The opposite sides at which the cover interaction elements are arranged are adjacent to the sides of the cover plate at which the cover fastening assemblies are arranged.

The stop and the actuator portion may be connected to the cover plate via a pivot connection. The pivot connection may be arranged between the stop and the actuator portion.

The stop may comprise a downwards facing portion or surface arranged to be supported by an upwards facing ledge. The ledge may be horizontal. In the present application the term “ledge” is intended to encompass a narrow edge.

In an embodiment of the storage system, the cover may comprise support legs arranged at opposite sides of the cover plate. The support legs may extend to a level below the cover holding assemblies, such that a second cover may be supported on top of a first cover arranged in a storage column. The first cover held at the predetermined level by the cover holding assemblies.

In an embodiment of the storage system, the cover holding assemblies may be pivotably connected to the support legs. The cover holding assemblies may be pivotably connected to the support legs by a pivot connection.

In an embodiment of the storage system, each of the cover interaction elements may be a plate (i.e. is plate-shaped) and/or may comprise a guide surface for interaction with the actuator portion of at least one of the cover holding assemblies. The guide surface may be substantially vertical, may comprise at least a section being inclined away from a centerline of the storage column in an upwards direction, or a combination thereof. In other words, the cover interaction elements may be cover interaction plates.

In an embodiment of the storage system, the ledge at the inner periphery of the storage column may be arranged on the cover interaction element, on a separate stop interaction element, on a horizontal profile or rail, the profile or rail may be arranged at an upper end of the storage column. The profile or rail may be part of a rail grid arranged at the upper level of the framework system.

In an embodiment of the storage system, the stop and the actuator portion may be arranged at opposite ends of a lever, the lever being pivotably connected relative to the cover plate.

In an embodiment of the storage system, the stop and the actuator portion may be separated by a vertical distance, such that the stop is in the first position when entering the opening of a storage column. The vertical distance may be at least equal to the height of a rail grid at the upper level of the framework structure.

In an embodiment of the storage system, the actuator portion may feature a follower for interaction with a guide surface of the cover interaction element. The follower may follow the guide surface of the cover interaction element to deflect the actuator portion inwardly. The follower may be a slidable or rotatable element. The rotatable element may be a wheel. The slidable element may feature a low-friction surface.

In an embodiment of the storage system, the stop may feature a downwards facing surface for interaction with the ledge. The cover may be suspended from or supported by the ledge via the downwards facing surface.

In an embodiment, the storage system may comprise at least one container handling vehicle and the upper level of the framework structure may comprise a horizontal rail grid upon which the container handling vehicle may move in two perpendicular directions, the container handling vehicle features a container lifting assembly able to raise storage containers from, and lower storage containers into, the storage columns, the container lifting assembly having a lifting frame, the lifting frame comprises gripping devices, and the storage containers and the cover comprise a corresponding interface for releasable connection to the gripping devices, such that the container lifting assembly may raise or lower any of a storage container and a cover.

In an embodiment of the storage system, the ledge may be arranged at a set level such that an upper level of the cover plate is below or at a top level of the framework structure. The top level of the framework structure may be the upper level of the rail grid.

In an embodiment of the storage system, the ledge may be arranged at a set level such that at least two covers may be stacked on top of each other while the cover plate of the upper cover is below a top level of the framework structure.

In an embodiment of the storage system, the at least one storage column featuring the cover interaction elements may comprise two barrier plates arranged on opposite sides of the inner periphery of the storage column, the opposite sides being different from the sides at which the cover interaction plates are arranged. Each of the barrier plates and the cover interaction elements may feature a rib, e.g. a cantilevered plate section, extending from the inner periphery of the storage column towards an adjacent storage column. The rib may be formed by a folded section of the barrier plates and/or the cover interaction elements. The rib may extend halfway between the inner periphery of the storage column in which the respective cover interaction plate or barrier plate is arranged and the inner periphery of the adjacent storage column. The use of both barrier plates and cover interaction elements may also provide increased stiffness of the framework structure.

In an embodiment of the storage system, the framework structure may comprise vertical column profiles defining the multiple storage columns, each of the storage columns is defined by four of the vertical column profiles, and each of the column profiles comprises four corner sections, wherein each corner section is arranged to accommodate a corner of a storage bin, and the inner periphery of each storage column may be defined by a rectangle delimited by the inner periphery of the corner sections of the four column profiles defining the storage column.

In an embodiment of the storage system, the cover plate may have a periphery substantially equal to the periphery of a storage container. The periphery of the cover plate may also be substantially equal to the inner periphery of a storage column.

In an embodiment of the storage system the framework structure may comprise vertical column profiles defining the multiple storage columns, each of the column profiles, in at least a section of the framework structure, comprises a lower profile section and an upper profile section made in an aluminium alloy, and the lower profile section and the upper profile section are interconnected and separated by a joint bracket made in a material having a lower thermal conductivity than the aluminium alloy. The joint bracket may also be termed a thermal break bracket.

In an embodiment of the storage system, the joint bracket is made in a suitable polymeric material. A suitable polymeric material may include any synthetic plastic material having a sufficient strength, such as various types of PVC, HDPE and PP.

In an embodiment of the storage system, the joint bracket may comprise a separation plate arranged between the lower profile section and the upper profile section, and at least one profile connecting element connected to the lower profile section and the upper profile section, the profile connecting element extending in a direction perpendicular to the plane of the separation plate.

The separation plate of the joint bracket may be horizontal. The profile connecting element may feature a first through hole for bolt connection to the lower profile section and a second through hole for connection to the upper profile section.

In an embodiment of the storage system, the cover interaction element is arranged at the level of the joint bracket. In other words, the ledge may be arranged at a set level such that the cover plate is at substantially the same level as the joint bracket. The ledge may be arranged at a set level such that a major part of the upper profile sections is above the cover plate.

In an embodiment of the storage system, at least a plurality of the storage columns may comprise a cover. The storage system may comprise a section of adjacent storage columns, wherein each storage column in the section may comprise or may be provided with a cover.

In an embodiment of the storage system, the cover may be provided with a layer of thermal insulation.

In an embodiment of the storage system, the cover is arranged to allow a human operator to stand on the cover at the upper level of the framework structure above a storage column.

In an embodiment, the storage system may comprise at least a section of adjacent storage columns, wherein each storage column features a cover, the section of storage columns may be isolated from the surroundings of the storage system by vertical wall panels. The wall panels may extend around the section of storage columns and may extend from a base level of the framework structure and at least up to the level of the covers.

In an embodiment, the storage system may comprise a cooling unit for cooling the atmosphere within the section of adjacent storage columns.

In an embodiment of the storage system the stop is part of a hook. The hook may comprise a downwards facing portion or surface that may interact with an edge at the inner periphery of the storage column, such that the cover is suspended within the storage column via the hook.

In a second aspect, the present invention provides a cover for a storage system according to any embodiment of the first aspect, the cover comprises a horizontal cover plate, support legs, and at least one cover holding assembly arranged at each of two opposite sides of the cover plate; each of the cover holding assemblies comprises a lever having a stop and an actuator portion, the lever is pivotably connected to a corresponding support leg, such that the stop is moved outwardly beyond a horizontal periphery of the cover plate when the actuator portion is moved inwardly towards a side of the cover plate being opposite the side at which the actuator portion is arranged.

The cover according to the second aspect may comprise any of the features of the first aspect related to a cover.

In a third aspect, the present invention provides a method of arranging a cover within a storage column of a storage system according to any embodiment of the first aspect, comprising the steps of:
lowering the cover into the storage column;
moving the stop into the second position by interaction of the actuator portion with the corresponding cover interaction element; and
holding the cover at a predetermined level relative to the storage column by interaction of the stop with a ledge at the inner periphery of the storage column.

In an embodiment of the method according to the third aspect, a vertical distance between the cover plate of the cover, i.e. an upper surface of the cover plate, held at the predetermined level, and an upper level of the storage column is larger than the height of a storage container; and the method comprises a step of:
lowering a storage container or a further cover onto the cover held at the predetermined level.

In a fourth aspect, the present invention provides a method of arranging a cover inside a column, the column comprises a pair of cover interaction elements and the cover comprises a horizontal cover plate having a periphery that can be accommodated within an inner periphery of the column and at least two cover holding assemblies arranged at opposite sides of the cover plate;
the two cover interaction elements are arranged at opposite sides of the inner periphery of the column;
each of the cover holding assemblies comprises a stop and an actuator portion, and is pivotably connected relative to the cover plate; and the method comprises the steps of:
   lowering the cover into the column;
   simultaneously deflecting the actuator portion inwardly of the inner periphery of the storage column by interaction with a corresponding cover interaction element, and moving the stop outwardly in a horizontal direction beyond the inner periphery of the storage column; and
   interacting the stop with a ledge at the inner periphery of the column to hold the cover at a predetermined level within the column.

In a fifth aspect, the present invention provides a framework structure for a storage system, the framework structure comprising vertical column profiles defining multiple storage columns, each of the column profiles, in at least a section of the framework structure, comprises a lower profile section and an upper profile section made in an aluminium alloy, and the lower profile section and the upper profile section are interconnected and separated by a joint bracket made in a material having a lower thermal conductivity than the aluminium alloy. In other words, the lower profile section and the upper profile section are interconnected and separated by a thermal break bracket.

In an embodiment of the storage system according to the fifth aspect, the joint bracket is made in a suitable polymeric material. A suitable polymeric material may include any synthetic plastic material having a sufficient strength, such as various types of PVC, HDPE and PP.

In an embodiment of the storage system according to the fifth aspect, the joint bracket may comprise a separation plate arranged between the lower profile section and the upper profile section, and at least one profile connecting element connected to the lower profile section and the upper profile section, the profile connecting element extending in a direction perpendicular to the plane of the separation plate.

In an embodiment of the storage system according to the fifth aspect, the at least one profile connecting element is positioned at a periphery of the separation plate.

In an embodiment of the storage system according to the fifth aspect, the at least one profile connecting element extends at both sides of the separation plate.

In an embodiment of the storage system according to the fifth aspect, the joint bracket may comprise four profile connecting elements evenly staggered around a centreline of the separation plate.

In an embodiment of the storage system according to the fifth aspect, the separation plate of the joint bracket may be horizontal, i.e. the separation plate may be arranged in a plane being perpendicular to the longitudinal direction of a vertical column profile.

In an embodiment of the storage system according to the fifth aspect, the profile connecting element may feature a first through hole for bolt connection to the lower profile section and a second through hole for connection to the upper profile section.

In an embodiment of the storage system according to the fifth aspect, the at least on profile connecting element may comprises a third through hole for connection of cover interaction elements that may be arranged within a storage column, a centreline of the third through hole being perpendicular to centrelines of the second and third through holes.

In an embodiment of the storage system according to the fifth aspect, the separation plate may comprise protrusions at each side, the protrusion arranged to be inserted into the ends of the upper and lower profile section being connected to the joint bracket. The protrusions may be configured to prevent lateral movement between the upper and the lower profile section.

In a sixth aspect, the present invention provides a joint bracket for a storage system according to the first or fifth aspect, the joint bracket comprising a separation plate arrangeable between a lower profile section and an upper profile section of a vertical column profile in a framework structure, and at least one profile connecting element connectable to the lower profile section and the upper profile section, the profile connecting element extending in a direction perpendicular to the plane of the separation plate.

In further embodiments of the sixth aspect, the joint bracket may comprise any of the features of the joint bracket defined in the fifth aspect.

In a seventh aspect, the present invention provides a vertical column profile for a storage system, the vertical column profile comprises a lower profile section and an upper profile section made in an aluminium alloy, and the lower profile section and the upper profile section are interconnected and separated by a joint bracket made in a material having a lower thermal conductivity than the aluminium alloy. In other words, the lower profile section and the upper profile section are interconnected and separated by a thermal break bracket.

In further embodiments of the seventh aspect, the joint bracket may comprise any of the features of the joint bracket defined in the fifth aspect.

### BRIEF DESCRIPTION OF THE DRAWINGS

Embodiments of the invention is described in detail by reference to the following drawings:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilevered section for carrying storage containers underneath.

FIG. 4 are side views of the container handling vehicle in FIG. 3, wherein a container lifting assembly is shown.

FIG. 5 is a perspective view of an exemplary storage system according to the invention.

FIG. 6 is a perspective view of a section of the storage system in FIG. 5.

FIG. 7 is an exploded view showing details of a storage column of the storage system.

FIG. 8 is perspective views of an exemplary cover according to the invention.

FIG. 9 is a perspective view of a joint bracket suitable for use in a storage system according to the invention.

FIG. 10 is a perspective view of an exemplary container handling vehicle of the storage system in FIG. 5.

FIGS. 11-13 are sectional views of an exemplary cover being arranged in a storage column of the storage system in FIG. 5.

FIGS. 14-18 are sectional views of a second exemplary storage system, wherein a cover is arranged at a higher level in a storage column of the storage system.

### DETAILED DESCRIPTION OF THE INVENTION

In the following, embodiments of the invention will be discussed in more detail with reference to the appended drawings. The drawings are not intended to limit the invention to the illustrated subject-matter.

An exemplary embodiment of the inventive storage system is described by reference to a cooled storage system as illustrated in FIG. 5. It is however noted that the features of the inventive storage system, in particular the covers 7 as described below, may be used to obtain other advantageous effects than maintaining a cooled atmosphere within a storage system.

The exemplary storage system 1′ according to the invention comprises a framework structure 100 featuring multiple storage columns 105 in which storage containers 106 are stored stacked on top of one another in vertical stacks 107. The storage system 1′ features a cooling unit 21 for cooling the atmosphere surrounding the storage containers 106, and vertical wall panels 20 arranged to insulate the sides of the storage system.

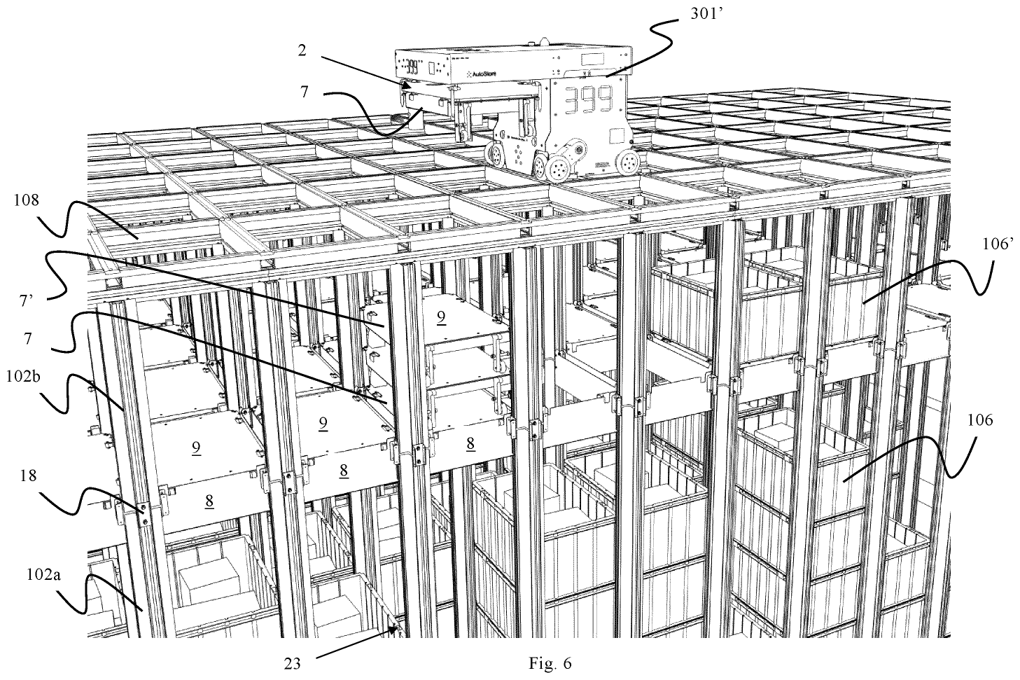

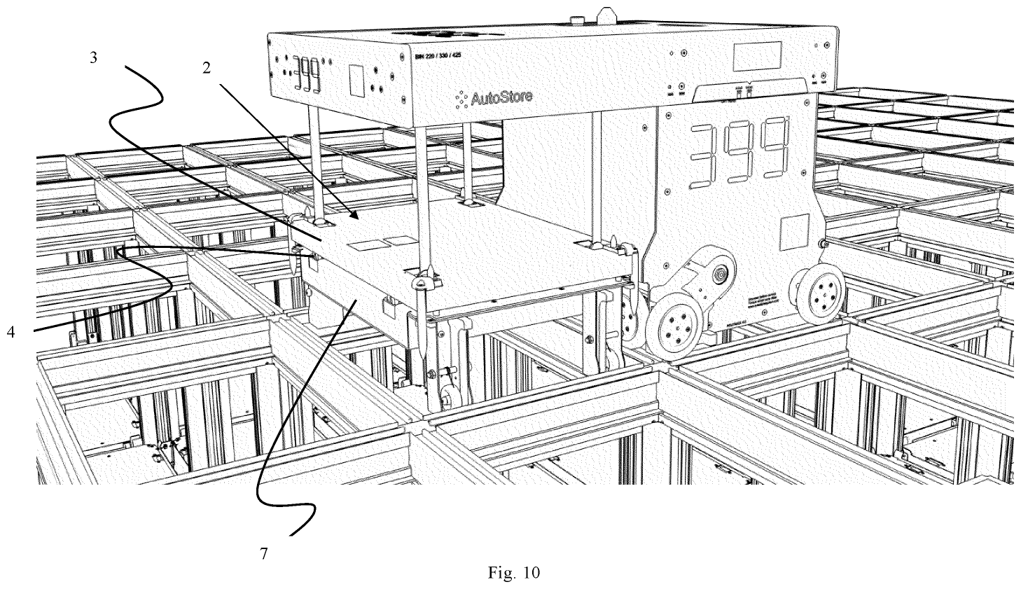

A container handling vehicle 301′ is arranged to move in two perpendicular directions on a horizontal rail grid 108 at an upper level of the framework structure 100. The container handling vehicle 301′ features a container lifting assembly 2, see FIGS. 6 and 10, able to raise storage containers 106 from, and lower storage containers into, the storage columns 105. The container lifting assembly 2 features a lifting frame 3 having gripping devices 4. The storage containers 106 and the covers 7 comprise corresponding interfaces 23, see FIGS. 6-8, for releasable connection to the gripping devices 4, such that the container lifting assembly 2 may raise or lower any of a storage container 106 and a cover 7.

The framework structure 100 comprises vertical column profiles 102 defining the multiple storage columns 105, and each of the storage columns 105 is defined by four of the vertical column profiles. Each column profile features four corner sections, wherein each corner section is arranged to accommodate a corner of a storage container 106.

Each of the storage columns features oppositely arranged cover interacting plates 8 for interaction with a cover 7 (i.e. cover interaction elements) lowered into the storage column 105. The cover interacting plates 8 are arranged at opposite sides of an inner periphery of the storage columns, are connected to the column profiles 102, and features a guide surface 29 facing the centreline of the storage column 105.

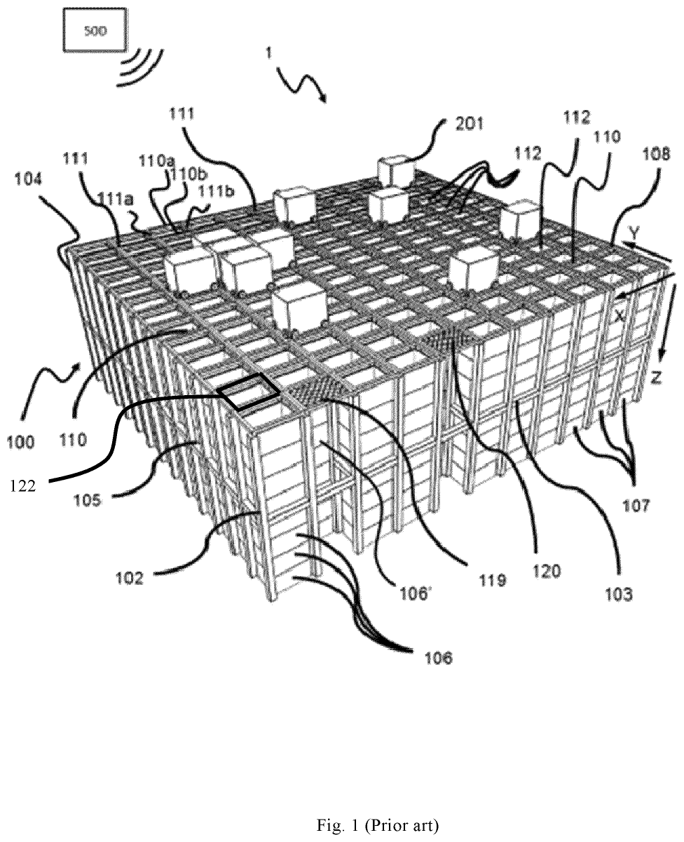

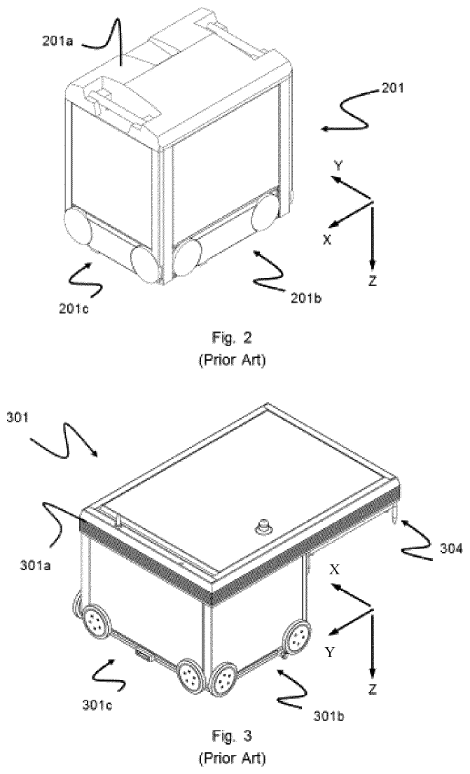

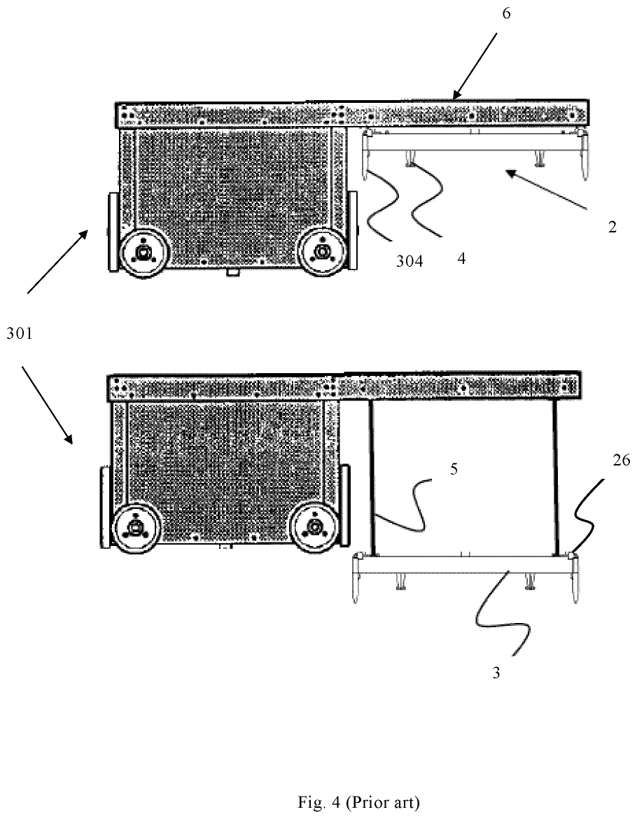

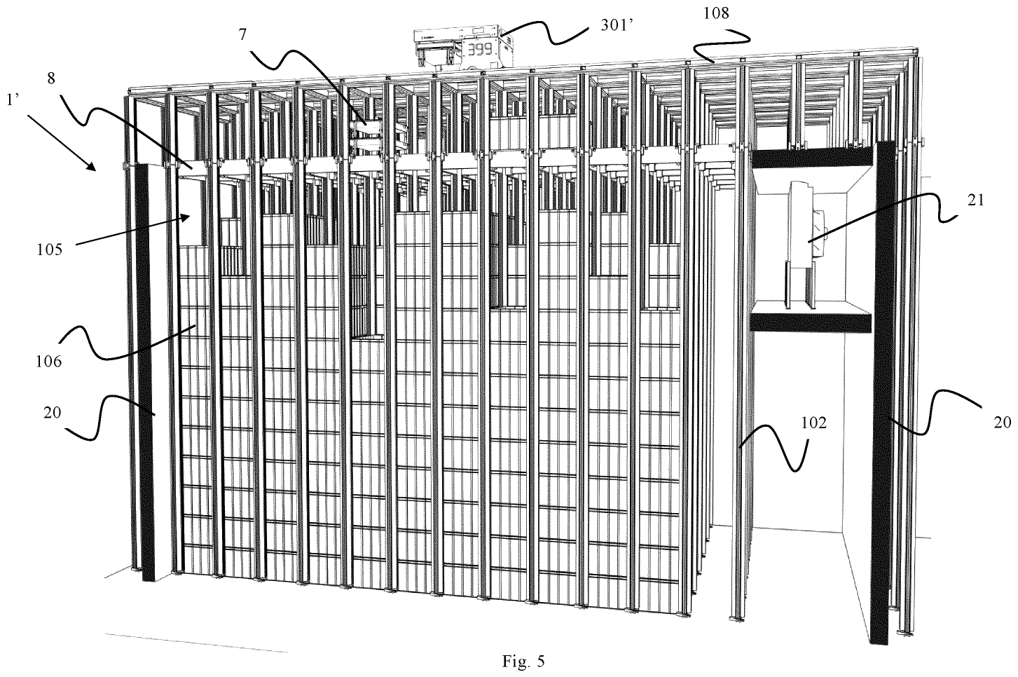

The inner periphery of each storage column 105 is defined by a rectangle delimited by the inner periphery of the corner sections of the four column profiles 102 defining the storage column. That is, the inner periphery of the storage columns 105 corresponds to the inner periphery of the rectangular opening of the storage columns. The inner periphery of the rectangular opening is defined by the sides of the rails 111,110, see FIG. 1, delimiting the opening.

The covers 7 may be arranged within the storage columns 105 at a predetermined level. The exemplary storage system 1′ features a cover 7 for each of the storage columns 105. In other embodiments, a storage system may for instance be divided into sections of storage columns 105, wherein only the storage columns 105 in some of the sections feature covers 7.

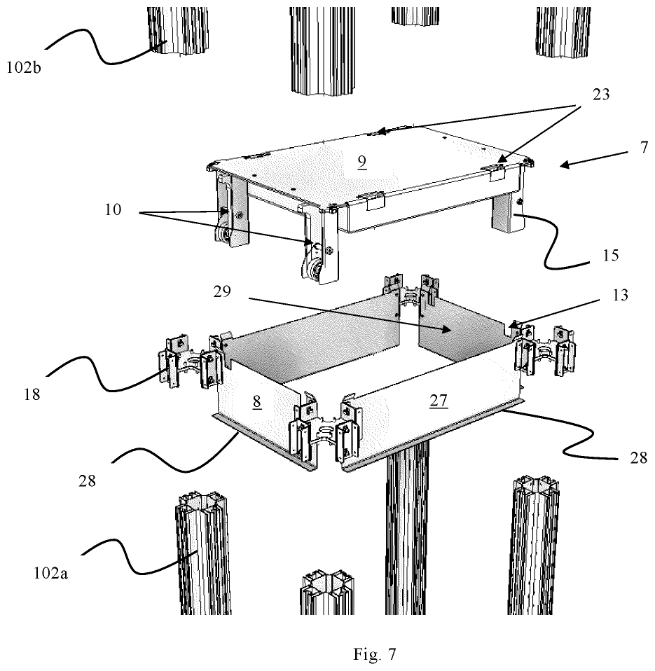

In the exemplary storage system 1′, each column profile 102 is further made up of a lower profile section 102a and an upper profile section 102b made in an aluminium alloy, see FIG. 7. The lower profile section 102a and the upper profile section 102b are interconnected and separated by a joint bracket 18 made in a material having a lower thermal conductivity than the aluminium alloy. The joint bracket 18 prevents thermal conduction between the cooled part of the storage system and the upper level of the framework at which the container handling vehicles operate. Preventing below zero temperatures at the upper level of the framework structure is highly advantageous in that potential problems caused by water condensation and/or icing on the horizontal rail grid 108 may be avoided. Such problems may include derailing of the container handling vehicles and loss of friction between the wheels of the container vehicle and the rail grid 108.

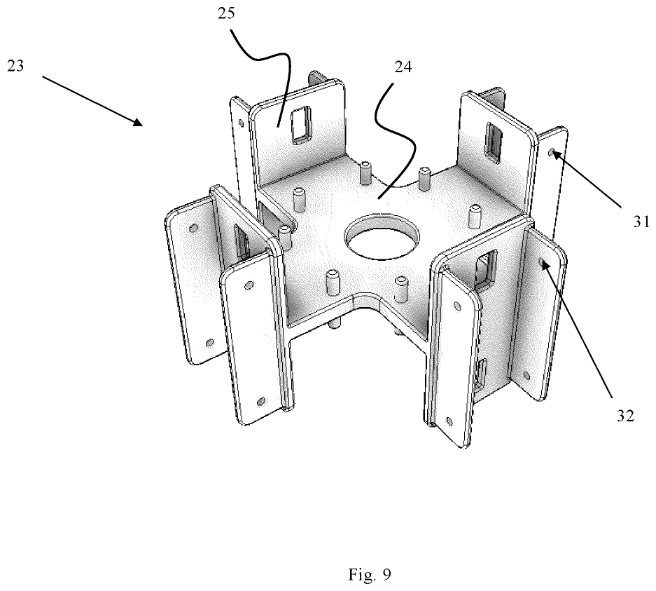

The joint bracket 18, see FIG. 9, is preferably made in a suitable polymeric material, including any synthetic plastic material having a sufficient strength, such as various types of PVC, HDPE and PP. The joint bracket 18 features a separation plate 24 arranged between the lower profile section 102a and the upper profile section 102b, and profile connecting elements 25 connected to the lower profile section 102a and the upper profile section 102b. The profile connecting elements 25 extend in a direction perpendicular to the plane of the separation plate. The thermal break provided by the joint bracket connecting the upper and lower profile sections may be highly advantageous in any storage system wherein a lower part of a framework structure is at a lower temperature than an upper part of the framework structure.

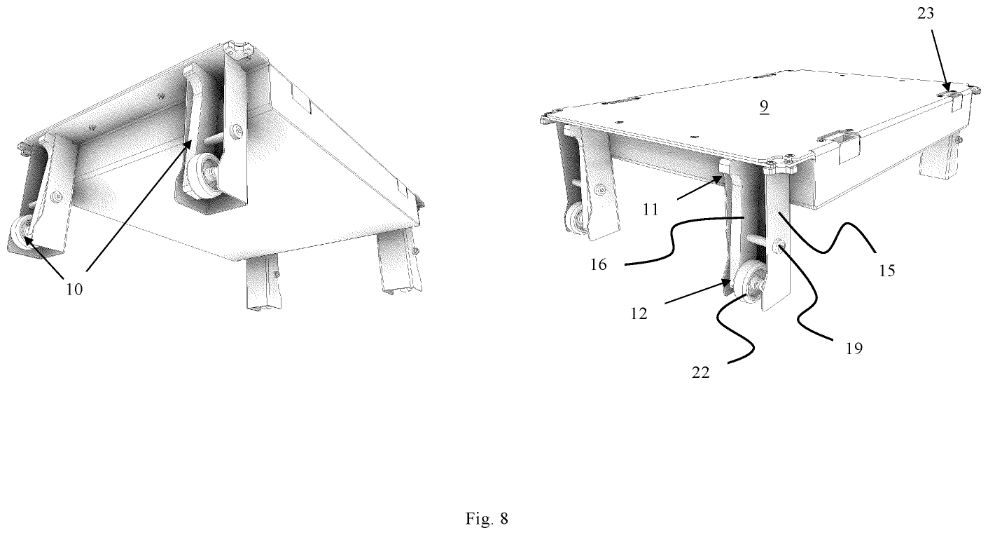

Each cover 7, see FIG. 8, features a horizontal cover plate 9 and four support legs 15. The cover plate 9 has a periphery that may be accommodated within the inner periphery of the storage column 105. The periphery of the cover plate 9 may be substantially equal to the periphery of the storage containers stacked within the storage columns 105. Four cover holding assemblies 10 are arranged in pairs at opposite sides of the cover plate 9. The cover plate is provided with interfaces 23 for releasable connection to gripping devices 4 of the container handling vehicle 301′. The upper surface of the cover plate 9 is preferably flat but may in other embodiments have any form provided the interfaces 23 may be accessed by the gripping devices 4.

The cover holding assemblies 10 feature a hook 11 (i.e. a stop) and an actuator portion 12. The hook 11 and the actuator portion 12 are arranged at opposite ends of a lever 16. The lever 16 is connected to the cover plate 9 via one of the support legs 15 by a pivot connection 19, see FIG. 8.

The actuator portion 12 features a wheel 22. The wheel 22 is arranged to interact with a corresponding cover interaction plate 8 (i.e. a cover interaction element) when the cover is lowered into the storage column 105. The wheel 22 ensures a smooth and quiet interaction between the actuator portion 12 and the cover interaction plate 8. In other embodiments, the wheel 22 may be replaced by any suitable sliding surface.

The pivot connection 19 ensures that the hook 11 is moved outwardly in a horizontal direction beyond the inner periphery of the storage column 105, from a first position to a second position, when the actuator portion 12 is deflected inwardly of the inner periphery of the storage column by interaction with the corresponding cover interaction plate 8. The hook 11 is biased towards the first position by a spring 26.

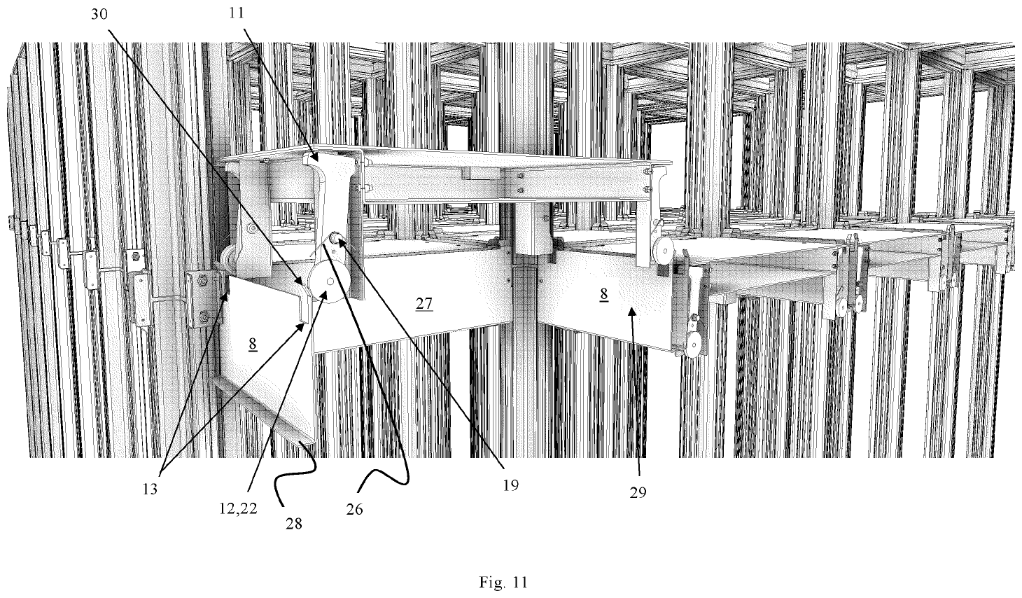

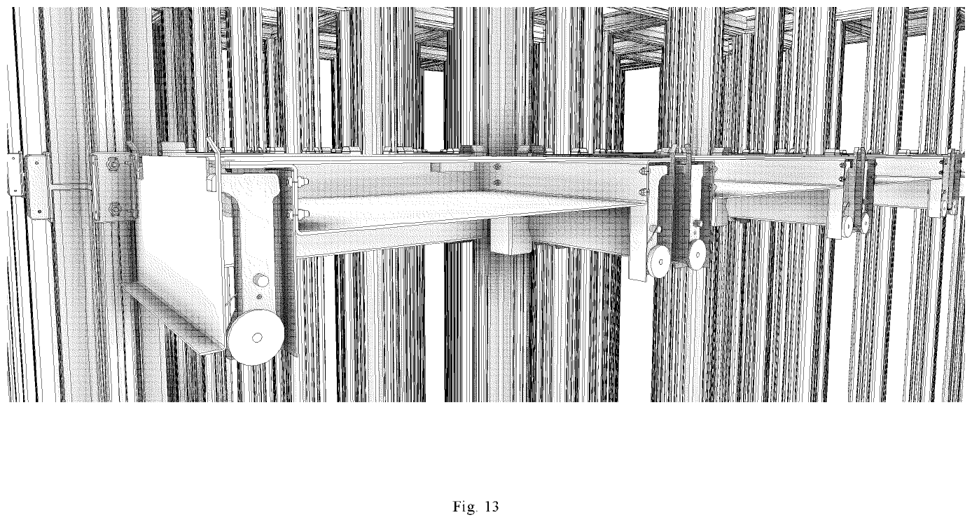

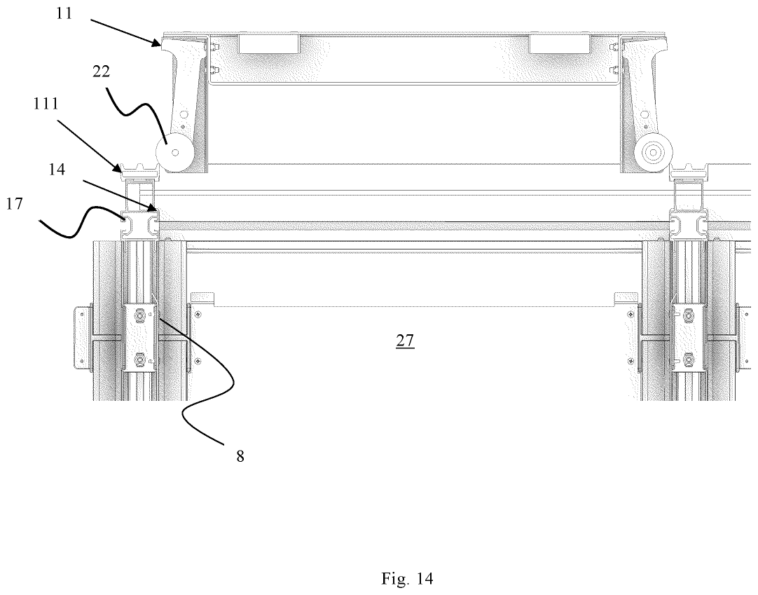

In the second position, a section of the hook 11, e.g. a downwards facing surface, extends beyond the inner periphery of the storage column to interact with a ledge 13,14 such that the cover is held at a predetermined level within the storage column. Depending on the desired or predetermined level, the ledge 13,14 may be arranged on the corresponding cover interaction plate 8, see FIG. 7 or 11, or on a side of the rail grid 108 defining the opening of the storage column 105, see FIG. 14.

In the exemplary storage system illustrated in FIGS. 5-7 and 10-13, the covers 7 may be arranged at a lower level within the storage column 105 to allow for the stacking of further covers 7′ and/or storage containers 106′ on top of the covers 7 held within the storage columns 105 by their cover holding assemblies 10. Having the covers 7 arranged at a lower level is highly advantageous in some applications of the cover 7, as it allows for a flexible organization of the storage containers and covers 7 during for instance digging operations as described in the background section.

The cooperative movement between the cover 7 and the cover interaction plates 8, allowing the cover to be held at a lower level within the storage column 105, is illustrated in FIGS. 11-13. The cover 7 is lowered into the storage column by a container handling vehicle 301′ as shown in FIG. 10, but the lifting frame 3 is not shown in FIGS. 11-13 for illustrative purposes.

In a first vertical position, see FIG. 11, the wheels 22 of the actuator portions 12 are in initial contact with the cover interaction plates 8. In the present embodiment, the cover interaction plate 8 features wheel contact sections 30 for providing a smooth initial contact with the wheels 22. The wheel contact sections 30 are inclined away from a centerline of the storage column in an upwards direction. The cover interaction plates 8 have edges 13 for the corresponding hooks 11.

After the initial contact, the cover 7 is lowered further into the storage column 105, see FIG. 12, and the actuator portion 12 is deflected inwardly of the inner periphery of the storage column 105. Simultaneously with the movement of the actuator portion 12, the hook 11 is moved outwardly from the first position to the second position. In the second position, a part of the hook 11 extends beyond the inner periphery of the storage column and above the edge 13.

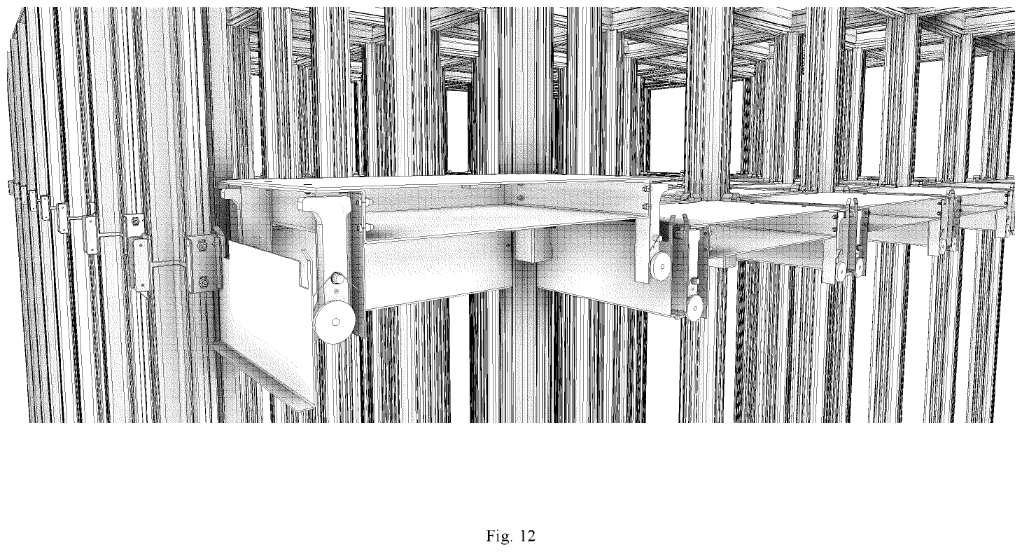

Finally, the cover is lowered until the hooks 11 are in contact with the corresponding edges 13, see FIG. 13, and the cover is suspended at the predetermined level within the storage column 105.

In addition to the cover interaction plates 8, the exemplary embodiment features two barrier plates 27 arranged on opposite sides of the inner periphery of the storage column 105. The barrier plates 27 and the cover interaction plates 8 feature a rib 28 extending from the inner periphery of the storage column 105 towards an adjacent storage column 105. When multiple adjacent storage columns 105 are equipped with covers 7, the ribs 28 close off the vertical space between the storage columns and prevent free passage of e.g. cold air to the upper level of the framework structure 100. In the exemplary embodiment, the barrier plates 27 and the cover interaction plates 8 are arranged within the storage column via through holes 31,32 on the joint bracket 18. However, in other embodiments the barrier plates 27 and the cover interaction plates 8 may advantageously be connected directly to the column profiles by e.g. bolts.

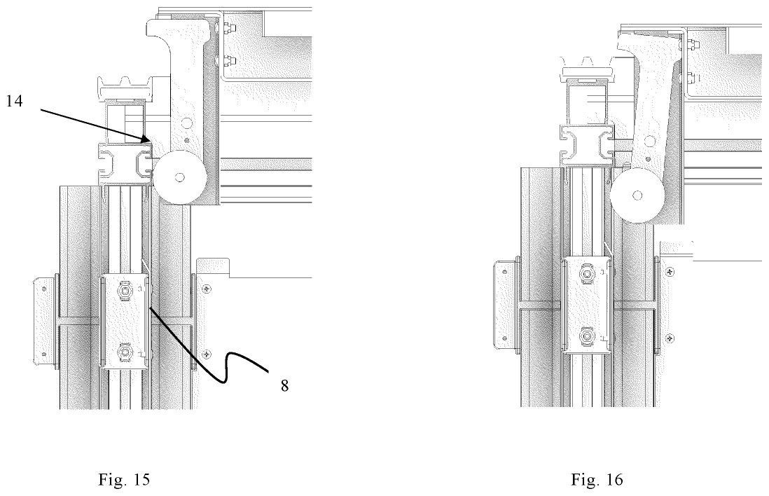

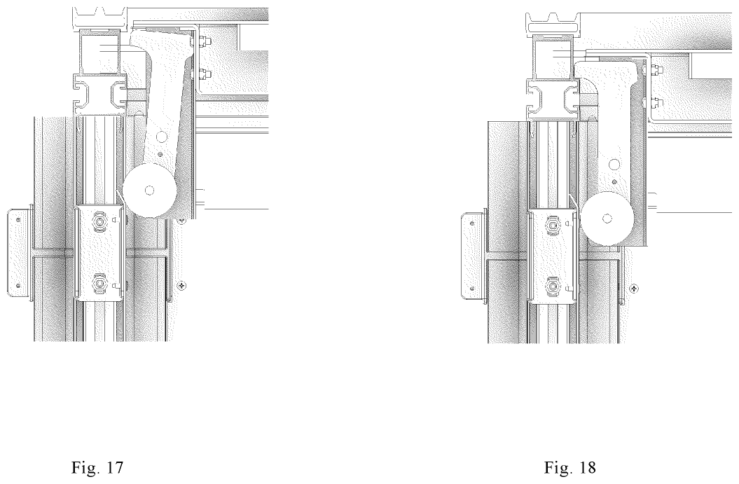

As mentioned above, the covers 7 may also be arranged at the upper level of the framework structure 100, see FIGS. 14-18 for an illustration of the cooperative movement between the cover 7 and the cover interacting plates 8. In this exemplary embodiment, the cover interaction plates 8 do not feature an edge via which the cover 7 is held in place. Instead the hook 11 of the cover 7 will interact with an edge 14 of a horizontal profile 17. The profile 17 is arranged below a rail 111 and is a part of the rail grid 108 arranged at the upper level of the framework structure 100. During the initial introduction of the cover 7 into the storage column 105, the wheel 22 of the actuator portion 12 will interact with the rail 111, see FIGS. 14 and 15, such that the hook 11 is moved outwardly to the second position beyond the inner periphery of the storage column 105. However, when passing the rail 111 during the further lowering of the cover 7, the hook 11 must be in the first position to avoid being stuck on top of the rails 111. Thus, the hook 11 and the actuator portion 12 are arranged at a distance from each other being sufficient to ensure that the actuator portion 12 is below the rail 111 and the profile 17 before the hook 11 is lowered to the upper level of the rail 111, see FIG. 16. The required distance between the hook 11 and the actuator portion 12 will depend on the height of the rail 111 and the profile 17. When the hook 11 is lowered below the upper level of the rail 111, the wheel 22 will come into contact with the cover interaction plates 8 and the hook 11 is moved into the second position to hold the cover 7 in place via the edge 14, see FIGS. 17 and 18.

Although the inventive storage system is described in detail by reference to a cooled storage system, the present invention is equally advantageous in any application wherein a controlled atmosphere is desired. Such applications may for instance entail filling the storage system with an inert gas, e.g. in case of a fire, introducing air having an increased CO₂ content and/or a specific moisture content when the storage system is used for cultivation of plants, i.e. vertical farming, and controlling the temperature. In yet an application of the present invention, the covers may be used to construct a path at the upper level of the framework structure, such that an operator may be allowed to walk on top of the storage columns. Methods of constructing a path for which the covers in the present invention are suitable are disclosed in WO 2019/081092 A1.

1. A storage system comprising a framework structure featuring multiple storage columns in which storage containers are stored stacked on top of one another in vertical stacks, and at least one of the storage columns comprises a cover and a pair of cover interaction elements, wherein
the cover comprises a horizontal cover plate, having a periphery that can be accommodated within an inner periphery of the storage column, and at least two cover holding assemblies arranged at opposite sides of the cover plate;
the cover interaction elements are arranged each at opposite sides of the inner periphery of the storage column;
each of the cover holding assemblies comprises a stop and an actuator portion, and is pivotably connected relative to the cover plate such that the stop is moved in a horizontal direction outwardly beyond the inner periphery of the storage column, from a first position to a second position, when the actuator portion is deflected inwardly of the inner periphery of the storage column by interaction with a corresponding cover interaction element during lowering of the cover relative to the storage column; and
the stop is biased towards the first position and arranged to hold the cover at a predetermined level by interaction with a ledge at the inner periphery of the storage column when in the second position.

2. A storage system according to claim 1, wherein each of the cover interaction elements is a panel and/or comprises a guide surface for interaction with the actuator portion of at least one of the cover holding assemblies.

3. A storage system according to claim 1, wherein the ledge at the inner periphery of the storage column is arranged on the cover interaction element or on a horizontal profile arranged at an upper end of the storage column.

4. A storage system according to claim 1, wherein the stop and the actuator portion are arranged at opposite ends of a lever, the lever being pivotably connected relative to the cover plate by a pivot connection arranged between the stop and the actuator portion.

5. A storage system according to claim 1, wherein the cover comprises support legs arranged at opposite sides of the cover plate.

6. A storage system according to claim 5, wherein the cover holding assemblies are pivotably connected to the support legs.

7. A storage system according to claim 1, wherein the actuator portion features a slidable or rotatable element for interaction with a surface of the cover interaction element.

8. A storage system according to claim 1, wherein the stop features a downwards facing surface for interaction with the ledge.

9. A storage system according to claim 1, wherein the framework structure comprises vertical column profiles defining the multiple storage columns, each of the column profiles comprises a lower profile section and an upper profile section made in an aluminium alloy, and the lower profile section and the upper profile section are interconnected and separated by a joint bracket made in a material having a lower thermal conductivity than the aluminium alloy, the material is preferably a suitable polymeric material.

10. A storage system according to claim 1, wherein at least a plurality of the storage columns comprises a cover.

11. A storage system according to claim 1, comprising at least a section of adjacent storage columns, wherein each storage column features a cover, the section of storage columns being isolated from the surroundings of the storage system by vertical wall panels.

12. A storage system according to claim 1, wherein the stop comprises part of a hook.

13. A cover for a storage system according to claim 1, the cover comprises a horizontal cover plate, support legs, and a cover holding assembly arranged at each of two opposite sides of the cover plate;
each of the cover holding assemblies comprises a lever having a stop and an actuator portion, the lever is pivotably connected to a corresponding support leg, such that the stop is moved beyond a horizontal periphery of the cover plate when the actuator portion is deflected inwardly towards a side of the cover plate being opposite the side at which the actuator portion is arranged.

14. A method of locating a cover within a storage column of a storage system comprising a framework structure featuring multiple storage columns in which storage containers are stored stacked on top of one another in vertical stacks, and at least one of the storage columns comprises a cover and a pair of cover interaction elements, wherein
the cover comprises a horizontal cover plate, having a periphery that can be accommodated within an inner periphery of the storage column, and at least two cover holding assemblies arranged at opposite sides of the cover plate;
the cover interaction elements are arranged each at opposite sides of the inner periphery of the storage column;
each of the cover holding assemblies comprises a stop and an actuator portion, and is pivotably connected relative to the cover plate such that the stop is moved in a horizontal direction outwardly beyond the inner periphery of the storage column, from a first position to a second position, when the actuator portion is deflected inwardly of the inner periphery of the storage column by interaction with a corresponding cover interaction element during lowering of the cover relative to the storage column; and
the stop is biased towards the first position and arranged to hold the cover at a predetermined level by interaction with a ledge at the inner periphery of the storage column when in the second position, the method comprising:
lowering the cover into the storage column;
moving the stop into the second position by interaction of the actuator portion with the corresponding cover interaction element; and
holding the cover at a predetermined level relative to the storage column by interaction of the stop with a ledge at the inner periphery of the storage column.

15. A method of locating a cover inside a column, the column comprising a pair of cover interaction elements arranged each on opposed sides of the column and the cover comprising a horizontal cover plate having a periphery that can be accommodated within an inner periphery of the column and at least two cover holding assemblies arranged at opposite sides of the cover plate;
the two cover interaction elements are arranged at opposite sides of the inner periphery of the column;
each of the cover holding assemblies comprises a stop and an actuator portion, and is pivotably connected relative to the cover plate; and the method comprises:
lowering the cover into the column;
simultaneously deflecting the actuator portion inwardly of the inner periphery of the storage column by interaction with a corresponding cover interaction element, thereby moving the stop in a horizontal direction outwardly beyond the inner periphery of the storage column; and
interacting the stop with a ledge positioned at the inner periphery of the column to hold the cover at a desired level within the column.
